(19) United States
(12) Patent Application Publication
(10) Pub. No.: US 2015/0286222 A1
(43) Pub. Date: Oct. 8, 2015

(54) Automatic Fluid Flow Control System

(71) Applicant: Kevin William Goldstein, Berwyn, PA (US)

(72) Inventor: Kevin William Goldstein, Berwyn, PA (US)

(21) Appl. No.: 14/246,042

(22) Filed: Apr. 5, 2014

(51) Int. Cl. G05D 7/06; G05B 15/02

(52) U.S. Cl. CPC G05D 7/0635; G05B 15/02

(57) ABSTRACT

Fluid flow control systems and methods are disclosed. In one preferred embodiment, the control system comprises a motorized shutoff valve controlled by logic output from a computer processor, where the computer processor compares input from a sensor measuring the current fluid flow rate against a relevant historical average of the fluid flow rate. If the current flow rate exceeds the relevant historical average fluid flow rate by at least a preselected percentage, then the computer processor transmits a logic signal to the motorized shutoff valve to close the fluid flow intake. If the current flow rate does not exceed the relevant historical average flow rate by the preselected percentage, the relevant historical average flow rate is updated by the current sensed flow rate. In different preferred embodiments, the method and systems may be used to control the flow of water, natural gas, propane, or fuel oil among other fluids.

### FIELD OF THE INVENTION

The present invention relates to systems used to control the flow of fluids such as water, natural gas, propane, or fuel heating oil. More particularly, this invention relates to a system and apparatus for automatically controlling the flow of a fluid based upon the recorded historical usage of the fluid.

The system generally includes a sensor for measuring the current flow of the fluid; a computer processor and memory for calculating the current flow rate, for comparing the calculated current flow rate to past recorded comparable flow rates, for setting appropriate logic signals to shutoff the fluid flow in specific situations, and for updating the data base of past flow rates; and a motorized shutoff valve, controlled by logic signals sent by the processor, in order to shut off or control the fluid flow if the current flow rate exceeds a preselected limit flow rate based upon the recorded historical flow rates.

As such, the present inventive system and apparatus provides automatic regulation of uncontrolled fluid flow or an automatic shut off of the fluid flow based upon a comparison with and analysis of prior fluid usage. This automatic control system increases safety of the fluid flow system, whether in residential or business properties, reduces property damage which may be caused by uncontrolled fluid flow, and reduces waste of the fluid resulting from any uncontrolled fluid flow.

### BACKGROUND OF THE INVENTION

Fluids such as water natural gas, or fuel heating oil are often supplied or transmitted to or within residential and business properties under pressure. The pressure may be from a third party utility providing the fluid under a pressurized infrastructure, such as a water main or a natural gas main. Such pressure may also simply be due to gravity and the weight of the fluid stored or maintained within a plenum or tank such as fuel heating oils. As such, the flow to, or within, a house Or facility is typically based upon a sensed demand for the fluid. That demand is determined primarily by a reduction in pressure at some location within the fluid infrastructure, and typically is caused by a demand of the fluid at the demand location (typically being an outdoor or indoor water faucet, water heater, oil furnace, propane stove, propane furnace, or other similar fluid demand apparatus). More particularly, as pressure is reduced at a location within the house or property fluid infrastructure, the fluid flows to that port or location.

If a leak, break or rupture occurs within the fluid infrastructure transmission line, a reduction in pressure is sensed at that location, and the system supplies the fluid to that location as demanded. However, once the leak or break occurs, unless or until the demand is removed, or the fluid flow is shutoff, the fluid will continue to flow through the leak, break or rupture in an uncontrolled state. This could, and often times does, result in substantial damage to the property at the site of the break or leak, along with a substantial loss of the fluid.

One prime example of this type of scenario or event is in water systems located in colder climates. Water within residential piping may freeze and later expand as a result of warming or thawing of the piping and water that occurs along with normal weather and temperature cycles. When this occurs, the infrastructure piping may develop a leak or rupture. When such water leaks or pipe breakage occurs, the water flows to the location of the leak or break in an uncontrolled state. If no one is present to shut down the water flow, the flow will continue to the site of the demand, with the result that the residence or property could be flooded and/or substantial water damage can occur.

Such events and scenarios are not uncommon. Indeed, insurance companies have noted that water damage due to residential water pipe failures is very substantial. According to the American insurance Association, “during the period 2007 to 2009, water leaks in homes resulted in property loss amounting to $9.1 billion. This is the equivalent to about twenty three percent of all property losses suffered by homeowners. The leaks and water damage are mainly caused by freezing pipes and plumbing failures . . . The average amount needed to repair water leaks can be over $20,880 on average. One study claims that up to ninety three percent of the damage caused by leaks could be avoided if there is a system in place that detects leaks. The same study claims that an automatic shut off system can also prevent damage.” www.insuranceqna/home˜insurance-statistics.html.

Various inventions and ideas have been developed to address this very real problem. By way of example, U.S. Pat. No. 7,561,057 (the “'057 patent”), issued to Kates for a Method and Apparatus for Detecting Severity of Water Leaks, teaches a system for detecting water leaks using a plurality of sensors selected from a moisture sensor, a water level sensor, and/or a water temperature sensor. According to the '057 patent, a processor collects input from the sensors, and if readings are above a moisture, water level, or water temperature threshold, then the processor reports a possible water leak. The '057 patent relies solely upon a plurality of sensors to identify a leak, and does not use or rely upon any sensed or identified abnormal usage.

Using a different design, U.S. Pat. No. 5,267,587 (the “'587 patent”), issued to Brown for a Utilities Shutoff System, discloses an automatic monitoring and shutoff system that senses pressure changes in a water or gas supply line. After sensing a pressure change, the system then shuts down of re-opens the supply lines based upon two trigger time delay means. More particularly, the system shuts off the water or gas supply line after a pressure change, and either maintains the shutoff of the supply line, or allows the second trigger time delay means to override the first trigger time delay means if the water and/or gas supply line returns to a normal pressure state within certain preset time periods. Importantly, the '587 patented system does not include any analysis or consideration of prior usage of the water or gas to determine whether the current usage is abnormal or normal.

Still further, PCT application number GB2004/003728 by Neil (the “'728 application”) for a system for Controlling Utility Supplies, discloses a system that includes a cut-off valve operated by a meter. The meter stores information about the supply consumption and can transmit the consumption information to a portable reader. As described in the '728 application, the control system is operated semi-automatically by the utility supply company to cat-off supply of the utility should the user not pay for the use of the utility, or not provide adequate credit to cover the usage of the utility supplied. Similar to the '587 patent and the '057 patent, the Neil '728 application system does not teach any analysis of or consideration of prior usage to automatically shutoff fluid usage where the current usage may he sensed as being abnormal.

Another system, described in U.S. patent application Ser. No. 11/888,093 (Pub. No. US2007/0289635) (the “'093 application”) by Ghazarian et al., for a Secure Wireless Leak Detection System, teaches a supervised wireless leak detection system. in the '093 application, in response to a detected leak, a processor controls a motor to close a supply valve, with such motor control being determined by previously stored pulse count numbers equal to prior pulse counts needed to close or open the supply valve. The '093 application provides no disclosure or suggestion of monitoring or recording prior fluid usage. The only recorded information appears to be prior rotational pulse counts necessary to open or close the supply valve.

A monitor and controller commercialized by Aquatrip Pty Ltd., and described in U.S. patent application Ser. No. 11/922,364 (Publication No. US 2011 0163249), for a Fluid Flow Monitor, uses in combination a fluid conduit with a magnet displaceable within the conduit when fluid flows therethrough; an electric circuit with a power supply; a magnetic sensor switch positioned in the electric circuit located adjacent to the conduit and positioned at a predetermined distance from the magnet when the magnet is not displaced, along with a timer connected to the electric circuit. As described in the '364 application, “[w]hen the magnet is displaced the predetermined distance, the magnetic sensor switch closes the electric circuit activating the timer and when the magnet is not displaced to the predetermined distance, the magnetic sensor switch opens the electric circuit deactivating the timer.” Similar to the above described inventions, the '364 application device and system provides no disclosure of monitoring and analyzing prior fluid flow usage as a means of determining the propriety of current fluid flow usage.

While each of these patents and applications describes a system, device or method to address the problems relating to uncontrolled fluid flow, including automatic water shutoff systems, as noted, none of these systems, devices or methods addresses the problem of controlling fluid flow based upon an analysis of and comparison to relevant comparable historical fluid flow rates that are stored and automatically updated in a processor's data memory. As such, the noted fluid flow control problem, as well as other related systems deficiencies, not addressed by any of the prior art systems or methods, are intended to be overcome and solved by the present invention.

Accordingly, it would be desirable to have a fluid flow control system and method that automatically shuts off the fluid flow if the current sensed flow rate exceeds a comparable historical flow rate by a preselected amount or percentage. Such improvements and results have not been seen or achieved in the relevant art.

### SUMMARY OF THE INVENTION

The above noted problems inadequately or incompletely resolved by the prior art are addressed and resolved by the present invention.

A preferred aspect of the invention is a fluid flow control system comprising a fluid flow sensor for sensing current fluid flow rate; a motor; a shut off valve actuated by the motor; a computer processor for determining an accurate current flow rate using at least one sensed current fluid flow rate; data memory for storing a plurality of historical fluid flow rates measured by the flow sensor after being processed by the computer processor; wherein the computer processor compares the determined accurate current flow rate to prior historical flow rates stored in the data memory, and if the determined accurate current fluid flow rate exceeds a prior comparable historical flow rate by at least preselected amount, then the processor transmits a signal to the motor to activate the shut off valve and thereby prevent further uncontrolled fluid flow.

Another preferred aspect of the present invention is a fluid flow control system comprising a flow sensor for sensing fluid flow a fluid main, a shut off valve, processor and data memory, wherein the fluid flow is controlled by the shut off valve based upon a comparison of the current flow rate with previously sensed and stored fluid flow rates.

Another preferred embodiment of the present inventive device is a method for controlling the flow of a fluid through a fluid transmission infrastructure; said method comprising the steps of sensing the current flow rate within the fluid transmission infrastructure; calculating an average flow rate from a plurality of the sensed current flow rates; comparing the average flow rate to a previously calculated average flow rate; actuating a flow control valve to shut down the fluid flow if the comparison of the current average flow rate with the previously calculated average flow rate shows that an abnormal flow condition exists; and updating said previously calculated average flow rate based upon the current calculated average flow rate.

Another preferred aspect of the inventive method for controlling fluid flow through a fluid transmission infrastructure as described in the prior paragraph, farther comprises the step of actuating a flow control valve to shut down the fluid flow if the current average flow rate continuously increases over a preselected period of time.

A further embodiment of the inventive method for controlling fluid flow through a fluid transmission infrastructure as described above, further comprises the step of actuating a flow control valve to shut down the fluid flow if the current average flow rate does not return to approximately zero at any point during a preselected period of time.

The invention will be best understood by reading the following detailed description of the preferred embodiments in conjunction with the drawings briefly described below.

### BRIEF DESCRIPTION OF THE DRAWINGS

For the purposes of illustrating the invention, the attached drawings show several embodiments that are presently preferred. However, it should be understood that the invention is not limited to the precise arrangement and instrumentality shown in the accompanying drawings.

FIG. 1: is a system block diagram illustration of a preferred embodiment of the inventive fluid flow control system to control fluid flow;

FIG. 2: is a block diagram illustration of a preferred embodiment of the computer processor communication including internal or external elements of a database memory, clock, and calendar;

FIG. 3: is an exemplary illustration of a preferred embodiment of the inventive fluid flow control system as installed within a residential property fluid infrastructure;

FIG. 4: is a flowchart of the steps of a preferred embodiment of the method to monitor and control fluid flow based upon comparison to stored historical flow rate data;

FIG. 5: is a flowchart of the steps of a preferred embodiment of the method to monitor and control fluid flow based upon comparison to historical flow rate data including the step of sending an alert signal to preselected wireless devices;

FIG. 6: is a system block diagram illustration of a preferred embodiment of the inventive fluid flow control system to control fluid flow including communication elements to send an alert signal to preselected wireless devices;

FIG. 7: is a flowchart of the steps of a preferred embodiment of the method to monitor and control fluid flow based upon comparison to historical flow rate data and to specifically control a slow leak scenario by monitoring whether the flow rate continuously increases;

FIG. 8: is a flowchart of the steps of another preferred embodiment of the method to monitor and control fluid flow based upon comparison to historical flow rate data and to specifically control a slow leak scenario by monitoring whether the flow rate returns to an approximate zero flow rate within a set period of time; and

FIG. 9: is a flowchart of the steps of a preferred embodiment of the method to monitor and control fluid flow based upon comparison to historical flow rate data and to further control a slow leak scenario by monitoring whether the now rate continuously increases or if the flow rate returns to an approximate zero flow rate within a set period of time.

### DETAILED DESCRIPTION OF PREFERRED EMBODIMENTS

The present invention is a method and system for automatically controlling fluid flow to reduce or prevent uncontrolled leakage and waste of the fluid when a leak or rupture occurs within a fluid transmission system. The inventive system comprises a flow sensor located near a main input location of the fluid transmission system, a motorized shutoff valve, and a processor to calculate a current flow rate and to compare that current flow rate to historical flow rates that are stored in data memory, such that if the current flow rate exceeds a comparable historical flow rate by a preselected amount or percentage, then the processor sends a signal to the motorized shutoff valve to close the valve and prevent further uncontrolled fluid flow.

The control system and method provide an effective means for monitoring residential and business fluid transmission systems, and automatically shutting off uncontrolled fluid flows, thereby preventing extensive property damage, and also alleviating the waste of the fluid. The control system can be readily retrofitted to current in-place fluid transmission systems, including residential and business property water lines water mains, propane or natural gas lines, and fuel heating oil lines. In other preferred embodiments, the system and method may be fairly easily retrofitted to one or more water mains, or gas mains used or owned by governmental or private entities, such as a township or city.

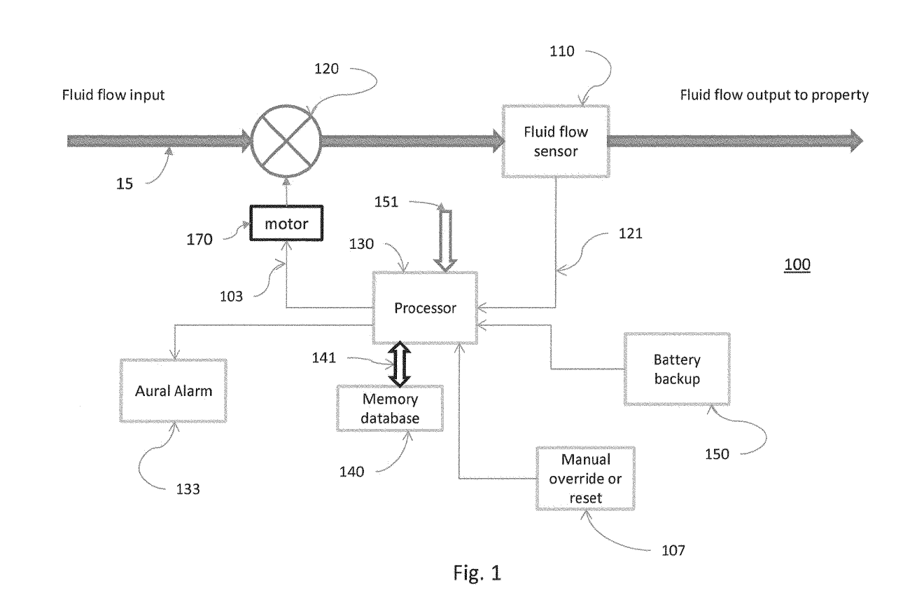

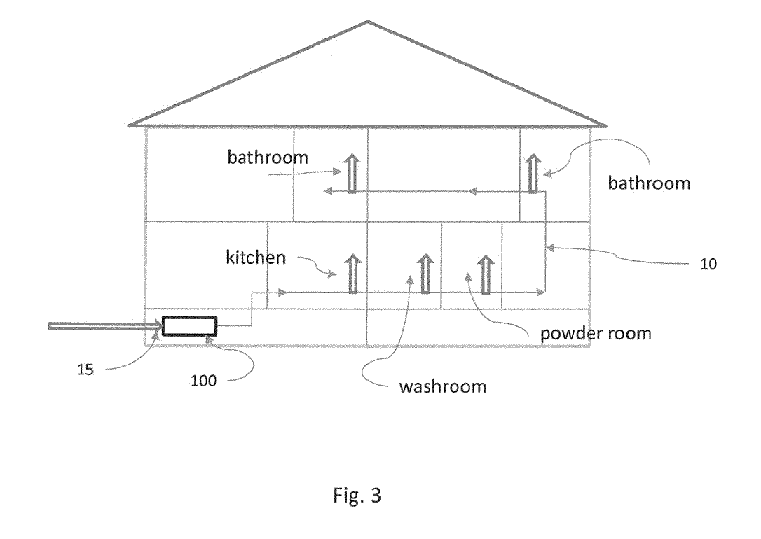

More particularly, as illustrated in FIG. 1, in a preferred embodiment, the inventive system may be incorporated into a fluid transmission system or infrastructure 10 within a residence or other building (see also FIG. 3). The system 100 includes, as shown in FIG. 1, a fluid flow sensor 110 measuring the fluid flow at or proximate to an input point 15 to the transmission infrastructure 10. White the fluid flow sensor 110 can be incorporated into the infrastructure 10 at most any location within the infrastructure 10, placing the flow sensor 110 as close as possible to a main input point 15 for the infrastructure 10 ensures that most any downstream leaks in the infrastructure 10 will be identified, and can then be controlled by the control system 100.

The control system 100 further includes a shutoff or control valve 120 incorporated into the transmission infrastructure 10 at a point that is also close to the primary fluid input point 15 into the property. As shown in FIG. 1, the control valve 120 should preferably be located at a point upstream of the fluid flow sensor 110 and downstream of the main input location 15.

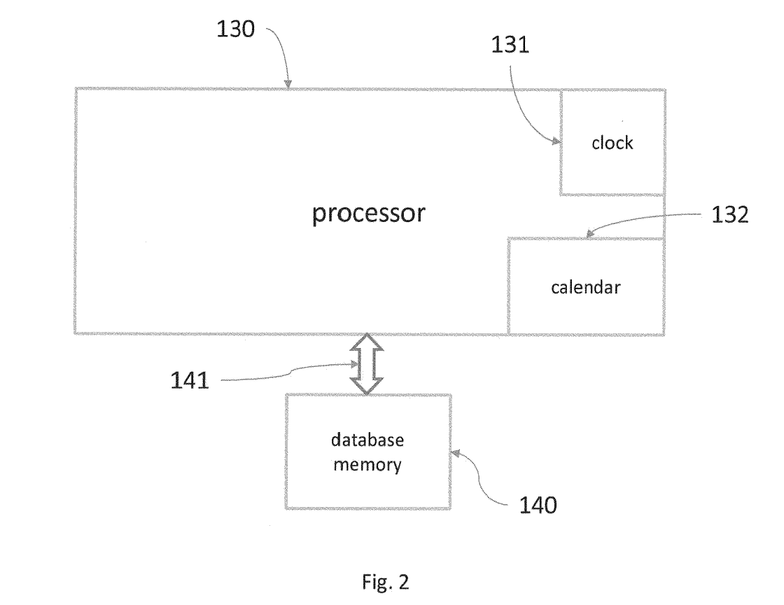

Further primary elements of the system 100 are a computer processor 130 and associated data memory 140. As further detailed in FIG. 2, the computer processor 130 further includes a clock 131 and calendar 132 such that the computer processor 130 can tag or identify the date and time of any event monitored by the computer processor 130. Such date and time tagging can be according to the true calendar year, month, date and time, or could be, alternatively, calendar year, month, day of the week, and time. While FIG. 2 illustrates the clock 131 and calendar 132, as being incorporated within the computer processor 130, in other equally effective embodiments, any or all of the clock 131, calendar 132, or data memory 140 may be separate from the computer processor 130 so long as they are communicatively coupled for real-time communication and transfer of data (as illustrated in FIG. 2 for the data memory).

During normal operation, the property electrical power grid supplies necessary electricity to the computer processor 130, control valve 120, and fluid flow sensor 110. To ensure that the control system 100 maintains operation even during a power outage, in a preferred embodiment, the computer processor 130, control valve 120, and fluid flow sensor 110 may also be powered, as shown in FIG. 1, by a back-up battery power supply 150.

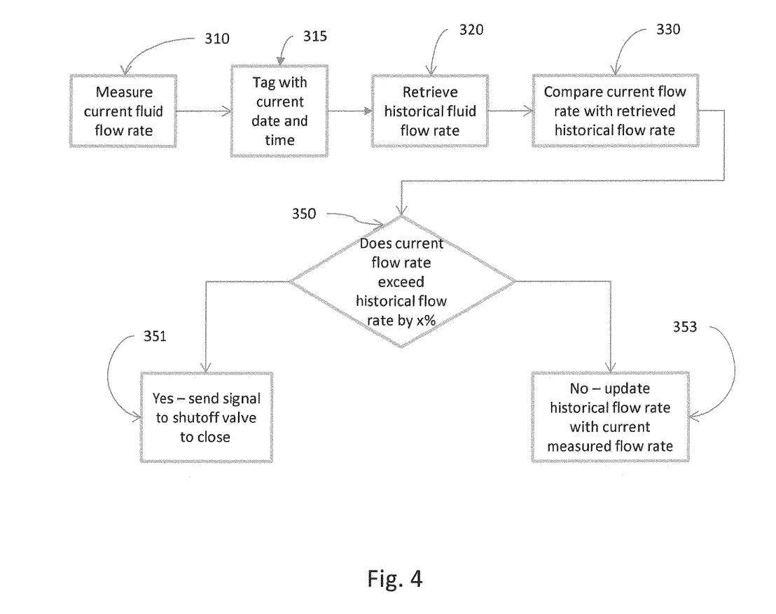

In operation, as illustrated in the FIG. 4 flowchart, and the FIG. 1 system diagram, the computer processor 130 receives flow rate input data 121 from the fluid flow sensor 110. Such input data 121 may be a single flow rate data packet or, in a preferred embodiment, a plurality of flow rates sensed over a short period of time. Upon receipt or measurement 310 of the input data from the fluid flow sensor 110, the computer processor 130 tags 315 the current input flow rate 121 with the current date and time as provided by the system clock 131 and calendar 132. Where the sensed flow rate 121 data is a plurality of flow rates, the processor 130 would first calculate an average flow rate for the time period sensed by the fluid flow sensor 110, and then tag 315 that calculated average flow rate with the appropriate current day and tie.

The computer processor next retrieves 320 relevant of comparable historical flow rate data 141 from the data memory 140. The comparable historical flow rate data 141 is, in a preferred embodiment, an average of historical flow rate data for the same relevant date and time as the current measured input flow rate. For example, in a preferred embodiment, if the current flow rate 121 is sensed on Saturday at 9:00 p.m., the processor 130 would retrieve from the data base memory 140, the running average of historical flow rates 141 for past Saturdays at 9:00 p.m. In a further and more detailed embodiment, the date and time could he more precisely recorded, stored and tagged to be a particular number date, such as January 23, at 9:00 p.m.

One reason for recording flow rate data based upon day of the week and time, as compared to true number or calendar date, is that in both residential and business properties, usage of water, heating fuels, or other fluids may be substantially different during normal business hours (e.g., Monday through Friday, between 8:00 a.m. and 6:00 p.m.), as compared to usage during non-business hours or during weekend hours. Further, in view of the date shift that occurs each calendar year, while January 23 may be a Friday this year, it could be a Saturday next year (unless the current year is a leap year). As such, comparing particular numerical dates may end up resulting in a comparison of usage between a weekday and a weekend, when, as noted, there may be substantial differences in such fluid usage on a weekend as compared to a weekday. Such differences in usage would possibly also apply similarly to water usage (e.g., doing more wash, or yard work on a weekend as compared to a weekday), and to heating fuel (e.g., heating a home en the weekend may entail more usage than a weekday when everyone is at work or at school).

Upon retrieval 320 of the historical flow rate 141, the computer processor 130 compares 330 the current flow rate 121 with the historical flow rate 141 to determine 350 if the current flow rate 121 is greater than the historical flow rate 141 by at least a preselected percentage 151 (shown in FIG. 1) that has been previously entered into, or stored in the processor 130. If the comparison 330, 350 made by the computer processor 130 shows the current flow rate 121 does exceed 351 the historical flow rate 141 by at least the preselected percentage 151, then the computer processor 130 identifies a fault condition in the fluid flow infrastructure, and sends 351 a signal 103 to the shutoff valve 120 to close the input or intake to the fluid flow infrastructure 10. If the comparison 330, 350 (shown in FIG. 4) thaws the current flow rate 121 does not exceed 353 the historical flow rate 141 by at least the preselected percentage 151, then the computer processor 130 updates the historical flow rate 141 with the current flow rate 121.

The preselected percentage 151 may be set permanently within the system 100 or processor 130 manufacturer, or it may be variable and thereby be set, or reset, by the property owner. Typical percentages 151 could be in the approximate range of 10% to 50%, although in a preferred embodiment, a preselected percentage 151 of approximately 25% would provide appropriate protection from severe leakages, yet provide enough of a buffer to eliminate false alarms resulting from normal different usage rates that may occur as part of normal different property needs.

In a further preferred embodiment (illustrated in FIG. 1), if a fault condition in the fluid flow infrastructure 10 is identified as a result of a comparison 330 of current usage to recorded prior usage, in addition to shutting down the flow valve 130, an aural alarm signal 133 can also be activated to alert residents or occupants in the property of the fault condition, and the fact that the fluid flow has been shutoff Through use of such an aural alarm 133, the occupant(s) of the property may be able to reset or override the fault condition by resetting or overriding the processor's logic output with a reset/override switch 107. Such override or reset 107 should only be used where the higher fluid usage is expected and the occupants have confirmed that there is no unexpected leak or fault condition within the flow infrastructure 10.

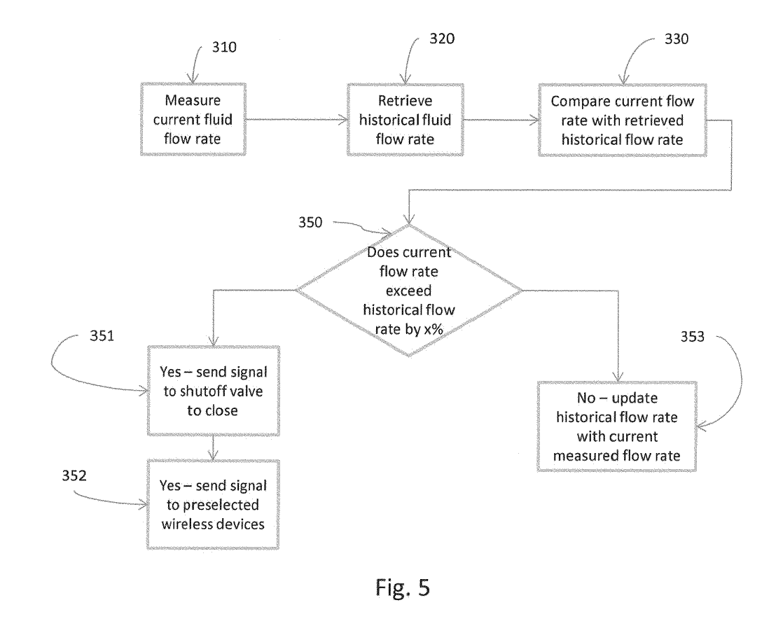

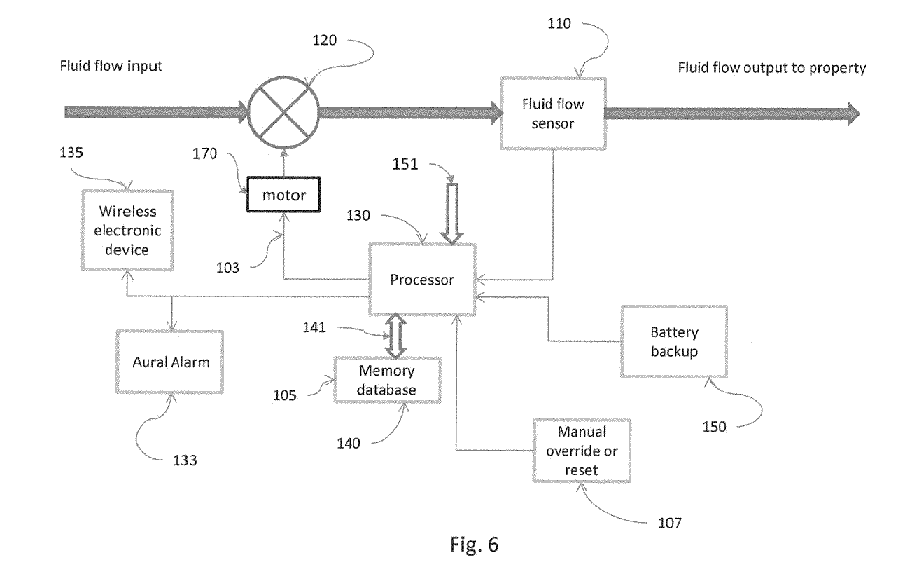

In a further preferred embodiment, as shown in the FIG. 5 flowchart, upon identifying a fault condition, the processor 130 can also send a signal 352 to one or more intended recipients, who may he remote from the property location, thereby alerting the recipients of the fault condition even if the recipients are remote from the property. Similar to current home and business alarm systems, such a fault or alarm signal 352 can be provided to any type of mobile or wireless device 135, as shown in FIG. 6, including a smartphone, tablet, or other similar mobile electronic device, and could be also provided to a central alarm company, who in turn could notify the property owners, the water company, or other authorities.

As also shown in FIGS. 4 and 5, if the computer processor 130 compares the current flow rate 121 with the relevant historical flow rate 141, and the current flow rate 121 is less than or equal to the historical flow rate 141 plus the preselected percentage 151, then the computer processor 130 does not identify a fault condition, and instead updates 353 the relevant historical flow rate 141 with the current measured flow rate 121. Such update can be by calculating an arithmetic or running average of the historical flow rate 141 for the number of data points monitored and used for the historical average. Such an arithmetic average calculation flow rate could be, in a preferred embodiment, be determined according to the following equation:

FR_{N}=(FRₓ₋₁+FRₓ)/N

where:
N=number of flow rates measured and included in the average
FR_{N} new average flow rate
FRₓ=current measured flow rate
FRₓ₋₁=prior average flow rate.

As shawl in FIGS. 1 and 6, the shutoff valve 120 is actuated by a motor 170 or is motorized, with the motor 170 being controlled by logic output 103 set by or sent from the computer processor 130. As described above, where the current flow rate 121 equals or exceeds the comparable historical flow rate 141 by the preselected percentage 151, then the computer processor 130 sets the logic gate 103 which in turn instructs the motor 170 to actuate the shutoff valve 120 to close the intake main for the fluid infrastructure 10.

One aspect or event that may not be recognized as a fault or abnormal condition by a simplified embodiment of the control system 100, is a slow leak, or an increase in usage that is less than the preselected percentage 151, even if such slow leak or increased usage is indeed a fault condition. More specifically, if there is a slow leak in the fluid transmission system 10 such that there is not rapid increase in fluid flow (as compared to the historical average 141), or where the increase is less than the preselected percentage 151, then the processor 130 will not identify a fault condition.

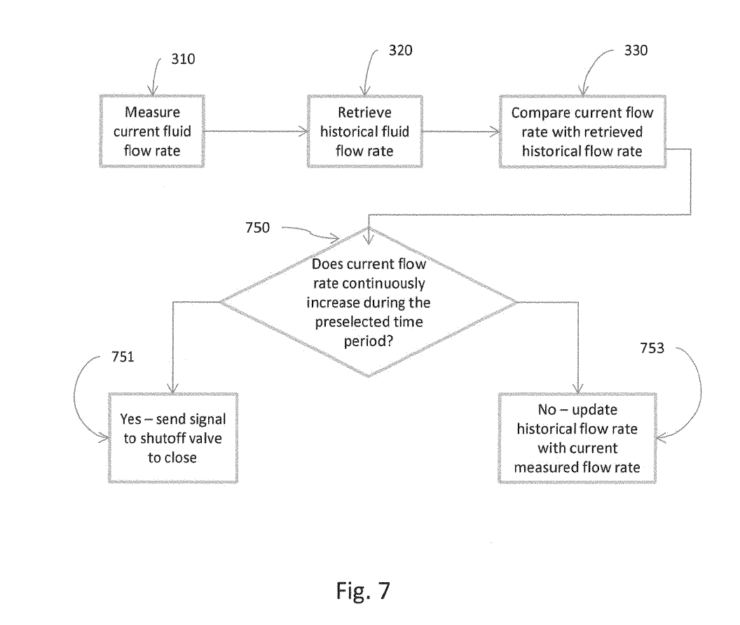

In a preferred embodiment, this problem or scenario may be accounted for by including further analysis by the computer processor 130. As illustrated in the FIG. 7 flowchart, the “slow creep” or “slow leak” increase in fluid flow may be addressed by monitoring fluid flow over a set measured period of time and determining 750 if the fluid flow has continually increased over the set measured period of time. If there is such a continual increase in fluid flow, then logic gate 103 may be set 751 identifying a fault condition and to actuate the shutoff valve 120 and close the intake main. If there is not a continued increase in fluid flow, then no fault condition is set, and the historical flow rate is updated 753 with the current measured flow rate.

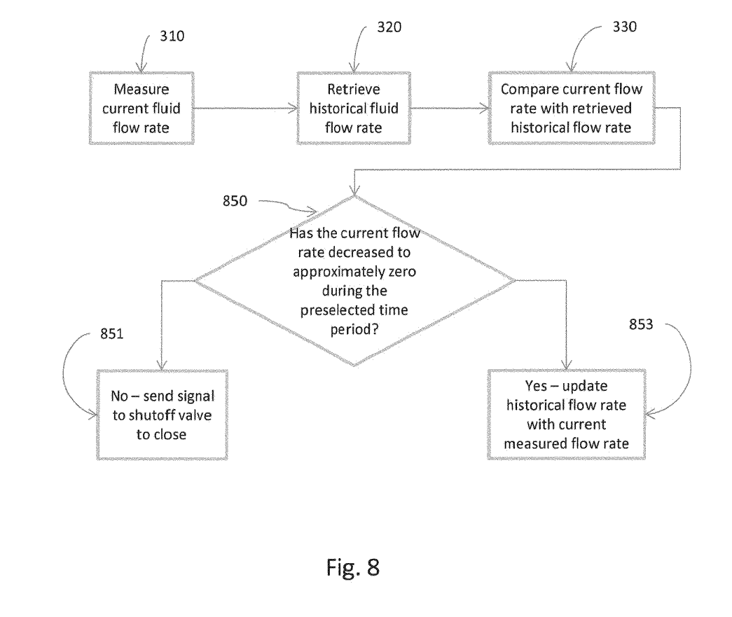

In a further preferred embodiment of the inventive fluid control system to alternatively address the “slow creep” issue, the computer processor 130, as shown in FIG. 8 monitors 850 the fluid flow over a set period of time. If the sensed current fluid flow rate 121 does not return to zero, or approximately to zero, at any point in time during the preselected measured period of time, then the computer processor 130 may set 851 the logic gate 103, and the shutoff valve 120 is actuated to shut down the intake main to prevent further likely fluid loss. As above, if the fluid flow rate has returned to zero or approximately zero during the preselected measured period of time, then no fault condition is set, and the historical flow rate is updated 853 with the current measured flow rate.

In preferred embodiments, the set period of time over Which the processor monitors the fluid flow to see if such flow continually increases, or returns to a near zero state, could be anywhere within the range of approximately 2 minutes to 30 minutes. Typically the cycle for residential toilet to refill after being flushed is in the range of 30 seconds (for a low volume toilet) to 90 seconds (for an older higher volume toilet). The preset time period to be measured should be at least as long as the time period for a toilet to refill. Accordingly, the preset time period could be set within the approximate range of 30 seconds to 2 minutes, although longer periods of time may also be used. A period of time that is much longer than 10 or 15 minutes could result in substantial property damage, so the shorter the monitored period time that is set, provides more protection for the property.

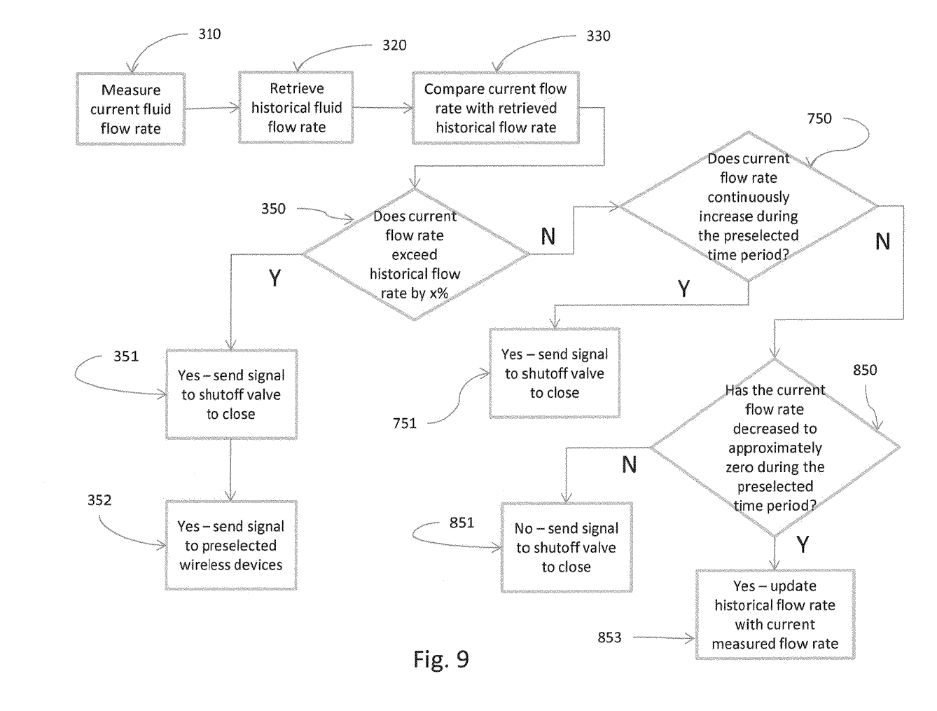

Either or both of the algorithms and control system analyses shown in FIG. 7 or 8 could, in an alternative embodiment, be combined with the processor algorithms and analyses of FIG. 3 or 4, as illustrated in FIG. 9 to create a more robust system 100.

While various preferred embodiments of systems and methods have been disclosed herein relating to fluid usage as part of a residential water transmission system as an exemplary embodiment, the inventive system and method has equal applicability to any fluid flow transmission system where the flow is based upon demand due to a pressure reduction within the fluid transmission system. By way of example, in other preferred embodiments, the inventive systems and methods have equal applicability to heating oil transmission lines, propane or natural gas transmission lines, and also to city or township water, gas, or oil transmission lines. Moreover, the inventive system and methods could be effectively incorporated into a traditional automobile gas filling station to monitor the flow of gasoline, or diesel fuel through one or more of the filling stations.

The above detailed description teaches certain preferred embodiments of the present inventive systems and methods to control fluid flow within residences, businesses, and townships or cities. While preferred embodiments have been described and disclosed, it will be recognized by those skilled in the art that modifications and/or substitutions are possible and such modifications and substitutions are understood to be within the true scope and spirit of the present invention. It is likewise understood that the attached claims are intended to cover all such modifications and/or substitutions.

What is claimed is:

1. A fluid flow control system comprising;
a fluid flow sensor for sensing current fluid flow rate;
a motor;
a shut off valve actuated by the motor;
a computer processor for determining an accurate current flow rate using at least one sensed current fluid flow rate;
data memory for storing a plurality of historical fluid flow rates measured by the flow sensor after being processed by the computer processor;
wherein the computer processor compares the determined accurate current flow rate to prior historical fluid flow rates stored in the data memory, and if the determined accurate current fluid flow rate exceeds a prior comparable historical flow rate by at least a preselected amount, then the processor transmits a signal to the motor to activate the shut off valve to stop fluid flow.

2. The fluid flow control system of claim 1, wherein the processor determines an accurate current flow rate by calculating an average current flow rate over preselected period of time, using input from the fluid flow sensor.

3. A fluid flow control system comprising: a flow sensor for sensing fluid flow in a fluid main, a shut off valve, and a processor and data memory, wherein the fluid flow is controlled by the shut off valve based upon a comparison of the current flow rate with previously sensed and stored fluid flow rates.

4. The fluid flow control system of claim 2, wherein the processor updates the historical flow rates stored within the data memory using the calculated average current flow rate.

5. The fluid flow control system of claim 1, further comprising a battery backup to power at least one of the computer processor, shut off valve, and fluid flow sensor, if normal operating power is interrupted.

6. The fluid flow control system of claim 1, further comprising a user activated override or reset switch to override the processor signal activating the shut off valve.

7. The fluid flow control system of claim 1, wherein if the determined accurate current fluid flow rate exceeds a prior comparable historical flow rate by at least a preselected amount, then the processor also transmits a status message to at least one remote wireless electronic device advising of a fault condition.

8. The fluid flow control system of claim 1, wherein the fluid being controlled is water.

9. The fluid flow control system of claim 1, wherein the fluid being controlled is selected from the group consisting of heating oil, natural gas, and propane.

10. The fluid flow control system of claim 1, wherein the preselected amount is approximately equal to 10% or greater of the prior comparable historical fluid flow rate.

11. The fluid flow control system of claim 1, wherein the processor further monitors and identities a fault condition where a continual leak is less than the preselected amount.

12. A method for controlling the flow of a fluid through a fluid transmission infrastructure; said method comprising the steps of
sensing the current flow rate within the fluid transmission infrastructure;
calculating an average flow rate from a plurality of the sensed current flow rates;
comparing the average flow rate to a previously calculated average historical flow rate;
actuating a flow control valve to shut down the fluid flow if the comparison of the current average flow rate with the previously calculated average historical flow rate shows that an abnormal flow condition exists; and
updating said previously calculated average historical flow rate based upon the current calculated average flow rate.

13. The method for controlling fluid flow through a fluid transmission infrastructure of claim 12, wherein the fluid being controlled is water.

14. The method for controlling fluid flow through a fluid transmission infrastructure of claim 12, wherein the fluid being controlled is selected from the group consisting of heating oil, natural gas, and propane.

15. The method for controlling fluid flow through a fluid transmission infrastructure of claim 12, further comprising the step of actuating a flow control valve to shut down the fluid flow if the current average flow rate continuously increases over a preselected period of time.

16. The method for controlling fluid flow through a fluid transmission infrastructure of claim 12, further comprising the step of actuating a flow control valve to shut down the fluid flow if the current average flow rate does not return to approximately zero at any point during a preselected period of time.

17. The method for controlling fluid flow through a fluid transmission infrastructure of claim 15, wherein the preselected period of time is approximately in the range of 30 seconds to two minutes. 18, The method for controlling fluid flow through a fluid transmission infrastructure of claim 16, Wherein the preselected period of time is approximately in the range of 30 seconds to two minutes.
